(19) United States
(12) Patent Application Publication
(10) Pub. No.: US 2025/0021895 A1
(43) Pub. Date: Jan. 16, 2025

(54) MANAGING PHYSICAL WORKSPACES WITH SENSOR DATA

(71) Applicant: Omnissa, LLC, Mountain View, CA (US)

(72) Inventor: ROHIT PRADEEP SHETTY, Bangalore (IN)

(21) Appl. No.: 18/370,420

(22) Filed: Sep. 20, 2023

(30) Foreign Application Priority Data
Jul. 13, 2023 (IN) 202341047185

(51) Int. Cl. G06Q 10/02

(52) U.S. Cl. CPC G06Q 10/02

(57) ABSTRACT

Disclosed are various approaches for managing physical resources in a physical workspace. Environmental data can be obtained from sensors in the physical workspace. A status map of the physical workspace can be generated. A space utilization plan can also be created that assigns users and events to areas of the physical workspace.

### RELATED APPLICATIONS

Benefit is claimed under 35 U.S.C. 119 (a)-(d) to Foreign application No. 202341047185 filed in India entitled “MANAGING PHYSICAL WORKSPACES WITH SENSOR DATA”, on Jul. 13, 2023, by VMware, Inc., which is herein incorporated in its entirety by reference for all purposes.

### BACKGROUND

In today's environment, smartphones and other devices are becoming more and more ubiquitous and more essential to users. Additionally, in modern office environments, efficient use of meeting rooms and other physical resources is important. Modern workspaces often utilize hot desks, zero-touch meeting rooms, social distancing policies, and daily booking of workspaces. The process for booking or reserving a meeting room or other conference facility within a corporate environment can be a cumbersome process. The reservation process can involve sending an email message or calendar invitation to a particular person in charge of booking the resource, who might respond with whether the room is available during a requested window of time.

In other examples, an email message or calendar invitation must be sent to an email inbox that is created for the meeting room, and an automated process can determine whether the room is available and create a calendar entry for the room within a calendar or scheduling system. In either scenario, however, while there exists some degree of automation or convenience, the user must still interact with an email or calendar infrastructure and know the correct email address or meeting room identifier to which a reservation request must be sent.

Additionally, users in a corporate environment may walk up to a meeting room, see that the room is unoccupied, and begin using the room without reserving the room within a reservation or calendar system, only to be kicked out of the meeting room by another user who has reserved the meeting room. This can disrupt workflows and cause inefficiencies in a corporate environment.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram depicting an example implementation according to various examples of the disclosure.

FIG. 2 is a flowchart that illustrates functionality according to examples of the disclosure.

FIG. 3 is a flowchart that illustrates functionality according to examples of the disclosure.

FIG. 4 is a flowchart that illustrates functionality according to examples of the disclosure.

### DETAILED DESCRIPTION

Disclosed are examples of a system that facilitates management of a physical workspace. In particular, examples of the disclosure facilitate management of physical resources. Physical resources can include desks, offices, cubicles, meeting rooms, conference facilities, furniture, or other physical assets that might be located in an office environment. In many office environments, the assignment, reservation, and/or booking of meeting rooms is often handled manually. In one example scenario, an electronic record is created for a hot desk, and a schedule or calendar is assigned to the electronic record. The electronic record is similar in many ways to an object that is created for a user within the directory service. The electronic record is assigned a calendar on which a schedule can be kept, an email inbox to which email messages and calendar invitations can be sent, and other descriptive data or metadata related to the physical resource.

Examples of the disclosure can facilitate space management of a physical workspace by providing additional technical features. For example, hot desks can be assigned based on suitability with an employee. Conference or meeting facilities can be assigned based on suitability with a particular event. Social distancing can also be provided based upon information obtained from managed devices about the state of a physical workspace. Additionally, these features can be provided without the need for manual intervention from a user or administrator.

Examples of the disclosure can rely upon sensors within a physical workspace, such as Wi-Fi access points, Bluetooth beacons or Bluetooth low energy beacons, audio/sound sensors, information from user devices, and other environmental data to generate a status map of a physical workspace. Using a status map, a space utilization application can generate a workspace utilization plan that assigns users and events to certain physical resources with the physical workspace. For example, the space utilization application can assign users and events to desks, cubicles, offices, conference rooms, meeting spaces, buildings, or other physical resources within a physical workspace. The space utilization plan can also utilize a management service with which enterprise devices are enrolled as managed devices to obtain information needed to generate a space utilization plan according to examples of the disclosure.

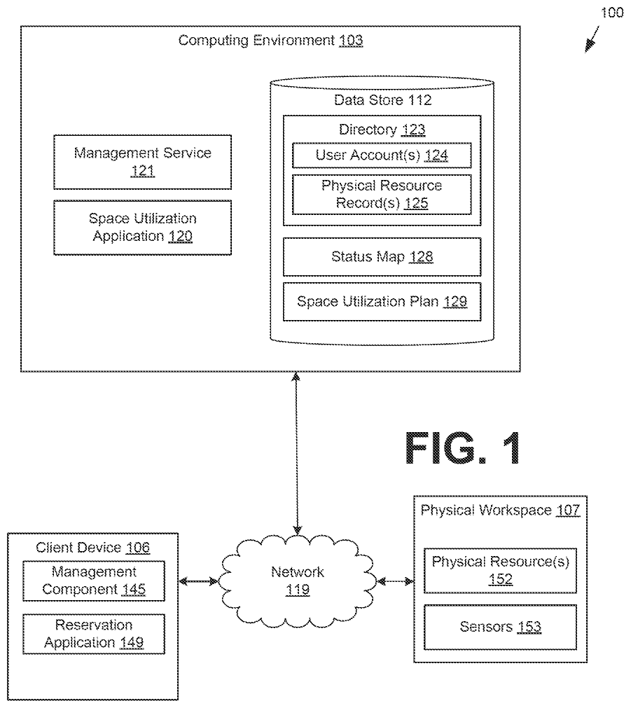

FIG. 1 illustrates an example of a networked environment 100 according to examples of the disclosure. In the depicted network environment 100, a computing environment 103 is in communication with at least one client device 106 and a physical workspace 107 over a network 119.

The network 119 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The computing environment 103 can be a computing environment that is operated by an enterprise, such as a business or other organization. The computing environment 103 includes a computing device, such as a server computer, that provides computing capabilities. Alternatively, the computing environment 103 can employ multiple computing devices that are arranged in one or more server banks or computer banks. In one example, the computing devices can be located in a single installation. In another example, the computing devices for the computing environment 103 can be distributed among multiple different geographical locations. In one case, the computing environment 103 includes multiple computing devices that together can form a hosted computing resource or a grid computing resource. Additionally, the computing environment 103 can operate as an elastic computing resource where the allotted capacity of computing-related resources, such as processing resources, network resources, and storage resources, can vary over time. In other examples, the computing environment 103 can include or be operated as one or more virtualized computer instances that can be executed to perform the functionality that is described herein.

Various applications or other functionality can be executed in the computing environment 103. Also, various data can be stored in a data store 112 that can be accessible to the computing environment 103. The data store 112 can be representative of a plurality of data stores 112. The data stored in the data store 112 can be associated with the operation of the various applications or functional entities described below.

The components executed on the computing environment 103 can include a space utilization application 120, a management service 121 and other applications, services, processes, systems, engines, or functionality not discussed in detail herein. The directory service 116 can include a service such as Microsoft Active Directory® that maintains user information and associates an identity with network resources such as electronic mailboxes, calendars, files, devices, or other resources. The directory service 116 provides authentication of users and associates the user's identity with the various resources that are provided within a corporate network infrastructure, such as a single sign-on service, email, calendar, contacts, file storage, print services, network access, and others. The directory service 116 can store information about users and physical resources within an enterprise.

The space utilization application 120 can include a special purpose service or application that can facilitate reservation of physical resources within an office environment. The space utilization application 120 can also facilitate assignment of users or events to offices, desks, conference rooms or other facilities. The space utilization application 120 can also generate a space utilization plan 129 that incorporates these assignments of users or events to physical resources. The space utilization plan 129 can also designate certain areas of a physical workspace 107 as quiet areas, congregation areas, social areas, high-traffic areas, low-traffic areas, or other area designations.

In some implementations, the space utilization application 120 can be a portion of an email or calendar service that is accessed by users using an email or calendar client to access emails, calendar invitations, or other items that appear on the user's calendar. In one example, the space utilization application 120 can receive requests to book or reserve a physical resource like a meeting room, determine whether the resource is available at the requested time window and provide a response to the requesting user or device indicating whether the resource is available to the requesting user or device and whether the resource has been booked or reserved by the space utilization application 120 on behalf of the requesting user or device.

The space utilization application 120 can generate a status map 128 of a physical workspace 107 based upon environmental data that can be obtained from sensors 153 that are located within the physical workspace 107. A sensor 153 can comprise a microphone, camera, network access point, such as a Wi-Fi access point, a beacon device, such as a Bluetooth beacon, motion sensors, occupancy sensors, or other types of sensors that can obtain information about the utilization of areas within a physical workspace 107.

In some implementations, the reservation functionality of the space utilization application 120 can be performed by a calendar service that determines whether the physical resource is available at a requested time, date, and duration. In this example, a physical resource can be associated with its own calendar or schedule just like another user having an identity within the directory service 116, and the physical resource can be booked just like any other users can schedule a meeting with one another using a calendar service. In contrast to a user determining whether his or her schedule maintained within a calendar service permits a meeting to be scheduled, the space utilization application 120 can make an automated determination based upon calendar data or a schedule associated with an electronic record of the physical resource within the directory service 116.

In some implementations or in certain cases, devices associated with users in a corporate environment can be managed devices that are enrolled with a management service 121. The management service 121 can be executed by the computing environment 103 in an on-premises implementation or in another computing environment that is separate from the computing environment 103. The management service 121 can also be provided with access to information about user accounts 124, physical resources 152, or other data associated with the space utilization application 120.

The management service 121 can be executed in the computing environment 103 to monitor and oversee the operation of one or more client devices 106 by administrators. In some examples, the management service 121 can represent one or more processes or applications executed by an enterprise mobility management (EMM) provider that facilitates administration of client devices 106 of an enterprise that are enrolled with the EMM provider. To this end, the operating system and application ecosystem associated with the client device 106 can provide various APIs and services that allow client devices 106 to be enrolled as managed devices with the management service 121. The management service 121 can initiate installation of applications as managed applications. The management service 121 can also initiate installation of configuration profiles that can be accessed by certain applications installed on a client device 106.

The management service 121 can include a management console that can allow administrators to manage client devices 106 that are enrolled with the management service 121. User interfaces can allow an administrator to define policies for a user account or client devices 106 associated with an enterprise environment. The user interfaces can also include, for example, presentations of statistics or other information regarding the client devices 106 that can be managed by the management service 121.

The data stored in the data store 112 associated with the directory service 116 can include a directory 123, a status map 128, a space utilization plan 129, and other data that can facilitate execution of the space utilization application 120 or management service 121. The directory 123 can include the various objects and data structures that are maintained by the directory service 116. Objects within the directory 123 can be organized into data structures, such as forests, trees, domains, organizational units, groups, partitions, or other organizational structures depending upon the directory service 116. Additionally, the directory 123 can be replicated across more than one data store 112 for redundancy purposes. The inner-workings and specific structure of the directory 123 are not shown or discussed herein, as they are not necessary for an understanding of examples of this disclosure.

Within a directory 123, electronic records or objects corresponding to user accounts can be created and stored. A user account 124 can correspond to a user having an identity within the directory service 116. Data associated with the user account 124 can also be stored in the directory 123 or in locations on a network specified by the directory 123. The data can include an email inbox, calendar data, documents or files, and other data stored by or associated with a particular user account 124. In some examples, user account 124 can be grouped into user groups by location, job function, or other grouping factors.

In the context of this disclosure, a physical resource record 125 can represent an electronic record in the directory 123 corresponding to physical resources. A physical resource record 125 in the directory 123 can correspond to a desk, a cubicle, a meeting room, a conference facility, or another physical resource in a physical workspace 107. A respective physical resource record 125 can specify metadata describing the physical resources 152 in the physical workspace 107. For example, a meeting room name, location, resources within a meeting room, and other metadata can be stored in the physical resource record 125. Additionally, a schedule and mailbox can also be stored within the electronic record or a location specified for the physical resource record 125. The mailbox can be an electronic mailbox to which reservation requests can be sent, and the schedule can include a schedule that is defined and formatted according to an enterprise calendar system, for example.

A status map 128 can represent a state of the physical workspace 107 that can be generated by the space utilization application 120 in response to environmental data about the physical workspace 107. The environmental data can be obtained from sensors 153 in the physical workspace 107 as well as client devices 106 that are enrolled with the management service 121 as managed devices. For example, a sensor 153 can comprise an audio or sound sensor that detects sound levels in a given area of the physical workspace 107. An area of the physical workspace 107 associated with high sound levels can be designated as highly occupied or at least as a congregation area of the physical workspace 107. Another example of environmental data can include data from a Wi-Fi access point in the physical workspace 107. The access point can report a number of devices to which it is connected, which can be utilized by the space utilization application 120 to determine how many people are located in a particular area of the physical workspace 107.

The status map 128 can comprise a map of the physical workspace 107 along with an estimate of how many people are located in each area of the physical workspace 107. The status map 128 can be updated in real time or periodically by the space utilization application 120.

The space utilization plan 129 can be a data structure that represents the physical workspace 107 that the space utilization application 120 can generate or update. The space utilization application 120 can assign users or events to physical resources 152 within the physical workspace 107 and store those assignments in the space utilization plan 129. The space utilization plan 129 can be synchronized with user and event electronic calendars. For example, the space utilization application 120 can assign a particular user to a given cubicle for a given day based upon a group membership of the user within the directory 123. The user can be assigned to a location within a particular floor of the physical workspace 107 based on where his or her colleagues from the same group within the directory 123 are located or have selected cubicles in a reservation system.

As another example, the space utilization application 120 can assign a meeting to a particular conference room in a designated quiet area based upon the sensitivity of documents that are attached to a meeting invitation or the privacy of the meeting invitation that has been circulated to the attendees.

The client device 106 can represent multiple client devices 106 coupled to the network 119. The client device 106 includes, for example, a processor-based computer system. According to various examples, a client device 106 can be in the form of a desktop computer, a laptop computer, a personal digital assistant, a mobile phone, a smartphone, or a tablet computer system. The client device 106 can represent a device that is owned or issued by the enterprise to a user, or a device that is owned by the user. The client device 106, when provisioned, can be enrolled with the management service 121 as a managed device of the enterprise. In some implementations, the client device 106 can be an unmanaged device that is not enrolled with a management service 121.

In one implementation, the client device 106 can execute a management component 145 that can communicate with the management service 121 to facilitate management of the client device 106. The management component 145 can communicate with the management service 121 to enforce management policies and compliance rules on the client device 106. For example, the management component 145 can enforce data security requirements, install, remove or update security certificates, or write, modify or delete certain data from the client device 106. The management component 145 can also monitor the client device 106, generate state information describing the client device 106, and provide the management service 121 with such state information. For example, the state information can include the network activity of the client device 106, the location of the client device 106, whether enforce password or personal identification number (PIN) authentication is enforced, and/or whether other compliance rules are being complied with by the client device 106. In one example, the state information can be generated by the management component 145 by receiving compliance rules from the management service 121 over the network 119, comparing the state of the client device 106 to the compliance rules, and determining whether the client device 106 fails to satisfy the compliance rules.

To carry out local management of a client device 106, the management component 145 can be installed and executed with elevated or administrative privileges on the client device 106. In some scenarios, the operating system of the client device 106 can allow a particular application or package to be identified as a device owner or a device administrator, which can in turn configure the client device 106 using such privileges. The client device 106 can also execute a reservation application 149. The reservation application 149 can allow a user to reserve or obtain assignment to a physical resource 152 within the physical workspace 107.

The physical workspace 107 represents space that can be managed by the space utilization application 120. The physical workspace 107 represents workspace within an enterprise, such as one or more floors, buildings, a campus, or other physical office space that can be accessed by users of an enterprise. The physical workspace 107 can include various physical resources 152, which can include desks, offices, cubicles, meeting rooms, conference facilities, furniture, or other physical assets that might be located in an office environment. The physical workspace 107 can also include various sensors 153 that can obtain and provide environmental data about the physical workspace 107. From the environmental data obtained from the sensor 153, the space utilization application 120 can determine the utilization of the physical workspace 107 and generate a space utilization plan 129 according to examples of the disclosure. A sensor 153 can include cameras, Wi-Fi access points, Bluetooth beacons or Bluetooth low energy beacons, audio/sound sensors, information from client device 106, information from user calendars, event calendars, calendars associated with physical resources 152, Internet-of-Things (IoT) sensors, and other environmental data obtained by the space utilization application 120.

The space utilization application 120 can generate a status map 128 representing the general location of users within the physical workspace 107 as well as the routes or pathways that are preferred by users within the physical workspace 107. The status map 128 can be supplemented using anonymized interaction of client device 106 with the sensors 153. The status map 128 can serve as a generalized heatmap and can be used to assign users to areas of the physical workspace 107 on a given day, week, month, or even permanently. In some examples, the status map 128 can be visualized in a user interface and accessed by users to understand which areas are generally occupied, are designated as congregation or teamwork areas, or are designated as quiet areas. The status map 128 can allow users to better plan their office visits based on their own needs or requirements (e.g., avoiding crowded areas, actively seeking teamwork opportunities, silent areas).

This status map 128 could be updated dynamically (every minute) and serve as a point of reference for employees. Alternatively, the heatmap could also be used by administrators or the space utilization application 120 to autonomously detect overcrowding or noise in certain areas and broadcast messages to user client devices 106 requesting them to not socialize or congregate in and around secure or silent locations within physical workspace 107 or warn them when noise levels in areas increase above a certain threshold based upon sensor 153 data.

The space utilization application 120 can be utilized to enforce or create silent or low noise areas. Areas in the physical workspace 107 can be designated as silent or low noise by an administrator. These can be areas around meeting rooms or board rooms when important meetings are scheduled. Silent or low noise areas can also be areas around certain individual work spaces or offices. To enforce these restrictions, the space utilization application 120 can utilize an alerting mechanism when detected sound levels exceed a decibel level threshold or when an area becomes more crowded than a designated threshold. For example, if there are important meetings scheduled in a meeting room, an area in proximity to the meeting room could be designated as a silent area. Any users loitering within that space are alerted on their client device 106 and requested to move. Users can be detected within that space based upon their respective client device 106 being connected to a network access point in the area or if their respective client device 106 is detected by a beacon device.

Meeting organizers can either designate meetings as private, quiet, or high priority so that the space utilization application 120 can assign the meeting to a conference facility within a quiet area. Alternately, the space utilization application 120 could designate meetings as high priority based on the agenda or the attendees. In these cases, when a meeting is designated as high priority, the space utilization application 120 can automatically enforce a silent area protocol in the vicinity of the meeting room.

In some examples, a user can designate his or her own cubicle as a silent area or the same could be done automatically by the space utilization application 120 based on past user patterns and choices. In one scenario, restrictions on sound, congregating, etc. are applied in staggered way originating from his or her cubicle. Accordingly, if the space utilization application 120, via the environmental data obtained from sensors 152, determines that there are other users in the vicinity that are causing noise levels to exceed a noise threshold, the users could be automatically alerted that they are exceeding the noise level of the designated area and could accordingly be requested to move to an empty meeting room which is capable of accommodating the crowd and is more sound insulated. The suggestion of which meeting room can be based on the number of employees part of the cluster and the detected noise level.

Alternatively, areas in the office could also be labeled as silent or low noise areas. Users can specify a preference for assignment to a silent or low noise area, and the space utilization application 120 can assign the user to a desk, cubicle, or office within the area when generating a space utilization plan 129 for the physical workspace 107.

Microphones on user client devices 106 could also be used to measure noise levels periodically in and around a user. The microphone of a client device 106 could be instead or in conjunction with sound sensors that are installed in the physical workspace 107. When sound levels are measured to be exceeding a certain threshold level in an area, the microphones on user devices in the area could be activated on for short durations to measure the sound levels in and around an individual area. These measurements could then be utilized to understand if a user is contributing to the high noise level or is silently working at his or her designated workspace. Accordingly, only users contributing to noise levels could be alerted by the space utilization application 120. Employees already utilizing microphones on their devices for a phone call or meeting on their devices could also be alerted based on the detected volume.

Thus, the space utilization application 120 can automatically push messages onto user devices in the vicinity alerting them or requesting them to take action to lower sound levels in a quiet or low-noise area, thereby limiting inconvenience and also any resulting friction between employees.

The space utilization application 120 can assign a user to a desk, cubicle, or office based upon historical usage patterns exhibited by the user. Patterns could be based on several factors, including past reservations booked by the user, historical usage patterns that are exhibited and detected on behalf of the user, and duration of the user's visit to office. For example, a user might generally select cubicles near a window, exit, a kitchen area, or other landmarks within the physical workspace 107. In these cases, the space utilization application 120 can assign the user to an area as close as possible to their previous usage pattern.

As another example, some users might frequently travel between different floors or buildings within the physical workspace 107. In these detected cases, the space utilization application 120 can assign the user to a location in proximity to an elevator, stairway, or exit. Other employees might frequently visit the printing rea for collecting printouts or copies. In this scenario, the space utilization application 120 can assign the user to a location close to the reprographics area makes most sense. Accordingly, based upon historical usage patterns of the user activity as detected by sensors 153 or client devices 106 of the users, the space utilization application 120 can analyze, deduce, and automatically allocate locations within the physical workspace 107 to users based upon the historical usage.

In some examples, assignment of cubicles, desks, or offices can also consider the job profile of the user and the sensitivity of their current work. For example, a user working on a document designated as high priority, secure, or confidential can be assigned to an isolated cubicle or meeting room within the physical workspace 107. A user in a particular group as specified in the directory service 116 can be assigned a location in the physical workspace 107 that is near other users in the same group.

Over time, the patterns exhibited by the user can be analyzed by the space utilization application 120 to create up with automatic reservations or bookings of physical resources 152 within the physical workspace 107 on behalf of the user rather than having a user or administrator manually select a physical resource 152, which might or might not be available based on the attendance for that particular day. This is especially useful in the case of a hot desk system or systems in which users are simply automatically assigned the first available desk in a physical workspace 107. New cubicles could be assigned to users based on their preference of low noise or a combination of factors such as medium noise plus distance to team, elevator area, etc.

Meeting rooms or conference facilities can similarly be automatically assigned to a user or to an event based upon the privacy level of the content associated with the meeting or a privacy or security level associated with the event itself. In some cases, meeting rooms can be assigned based upon proximity of the room to the assigned cubicle, desk, or office of the attending users.

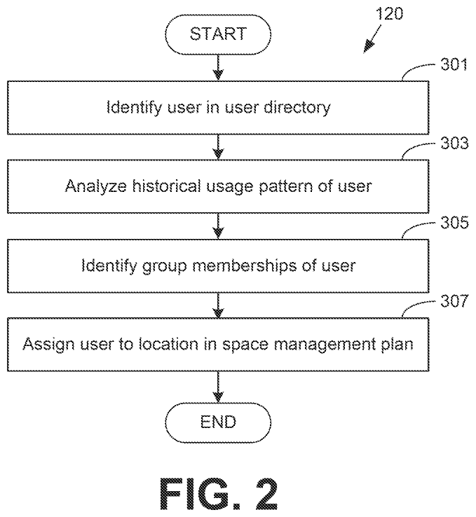

Referring to FIG. 2, shown is a flowchart that provides one example of how the space utilization application 120 can generate a space utilization plan 129 that assigns users to particular locations within a physical workspace 107. As noted above, the space utilization application 120 can generate a status map 128 representing the general location of users within the physical workspace 107 as well as the routes or pathways that are preferred by users within the physical workspace 107. The status map 128 can be supplemented using anonymized interaction of client device 106 with the sensors 153. The status map 128 can serve as a generalized heatmap and can be used to assign users to areas of the physical workspace 107 on a given day, week, month, or even permanently. In some examples, the status map 128 can be visualized in a user interface and accessed by users to understand which areas are generally occupied, are designated as congregation or teamwork areas, or are designated as quiet areas. The status map 128 can allow users to better plan their office visits based on their own needs or requirements (e.g., avoiding crowded areas, actively seeking teamwork opportunities, silent areas).

Accordingly, at step 301, the space utilization application 120 can identify a user in the directory service 116. At step 303, the space utilization application 120 can analyze a historical usage pattern of physical resources 152 in the physical workspace 107 by the user. The space utilization application 120 can assign a user to a desk, cubicle, or office based upon historical usage patterns exhibited by the user. Patterns could be based on several factors, including past reservations booked by the user, historical usage patterns that are exhibited and detected on behalf of the user, and duration of the user's visit to office. For example, a user might generally select cubicles near a window, exit, a kitchen area, or other landmarks within the physical workspace 107. In these cases, the space utilization application 120 can assign the user to an area as close as possible to their previous usage pattern.

As another example, some users might frequently travel between different floors or buildings within the physical workspace 107. In these detected cases, the space utilization application 120 can assign the user to a location in proximity to an elevator, stairway, or exit. Other employees might frequently visit the printing rea for collecting printouts or copies. In this scenario, the space utilization application 120 can assign the user to a location close to the reprographics area makes most sense. Accordingly, based upon historical usage patterns of the user activity as detected by sensors 153 or client devices 106 of the users, the space utilization application 120 can analyze, deduce, and automatically allocate locations within the physical workspace 107 to users based upon the historical usage.

At step 305, the space utilization application 120 can identify group memberships of the user within the directory service 116. In some examples, a user in a particular group as specified in the directory service 116 can be assigned a location in the physical workspace 107 that is near other users in the same group.

At step 307, the space utilization application 120 can assign the user to a location in the physical workspace 107 by updating the space utilization plan 129 accordingly. Thereafter, the process can proceed to completion.

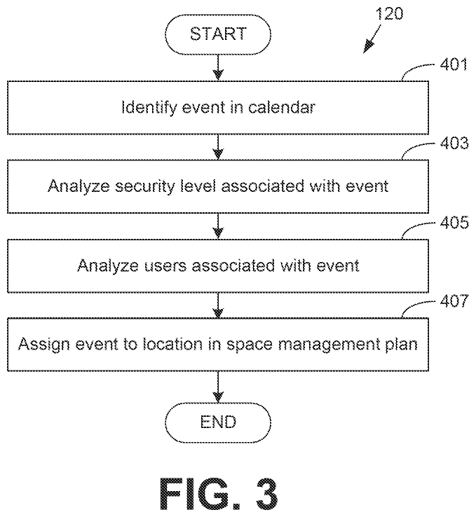

Referring next to FIG. 3, shown is a flowchart that provides one example of how the space utilization application 120 can assign events to locations within the physical workspace 107 and in the space utilization plan 129 according to various examples.

Beginning at step 401, the space utilization application 120 can identify an event in a calendar. In one example, the space utilization application 120 can be invoked when a user requests a meeting location in a calendar user interface. In another example, the space utilization application 120 can have access to the calendars of the various meeting spaces and conference facilities in the physical workspace 107 and assign events to the various physical resources 152 on behalf of users in the enterprise.

At step 403, the space utilization application 120 can analyze the security of an event. Meeting rooms or conference facilities can similarly be automatically assigned to a user or to an event based upon the privacy level of the content associated with the meeting or a privacy or security level associated with the event itself. In some cases, meeting rooms can be assigned based upon proximity of the room to the assigned cubicle, desk, or office of the attending users.

In one example, if the meeting is designated by a meeting organizer as private, the space utilization application 120 can determine that a private meeting area or one that is located in a quiet or low-noise area should be selected. In another example, the security or privacy level of a meeting can be ascertained by the content (files) associated with the meeting, the security status of the email thread (if any) which resulted in the creation of the meeting based upon a textual analysis of the email thread, the identity of the meeting attendees or an explicit privacy level set for the meeting by the organizer. Depending on these factors, a user is automatically suggested a meeting room during the time of the booking. If the space utilization application 120 determines that the security level of the meeting requires a secure, private, or quiet meeting facility, the space utilization application 120 can suggest or assign the location to the user.

At step 405, the space utilization application 120 can analyze the users invited to the meeting invitation. The identity of the users can drive selection of the meeting location by the space utilization application 120. For example, the space utilization application 120 can consult the space utilization plan 129 to determine the location users as assigned by the space utilization application 120. The space utilization application 120 can select a meeting location that is in proximity to the users based upon their assigned location in the space utilization plan 129.

In some cases, where a teleconference or videoconference is selected by the meeting organizer and a user's presence is detected on the office premises, a meeting room can automatically be suggested for the user and the user can be notified on his or her client device 106 before the meeting time. The user can conduct the meeting from the meeting location. In this scenario, not just the privacy level associated with the meeting but even the equipment support of the meeting room would be taken into account. In the case of a meeting created in a calendar without a meeting room booked, the space utilization application 120 can suggest meeting rooms to the organizer at a predefined interval before the meeting if the user presence is detected on the office premises.

At step 407, the event is assigned to a location within the physical workspace 107. The space utilization plan 129 can be updated to assign the event to the specified meeting time and to the specified meeting location. Thereafter, the process can proceed to completion.

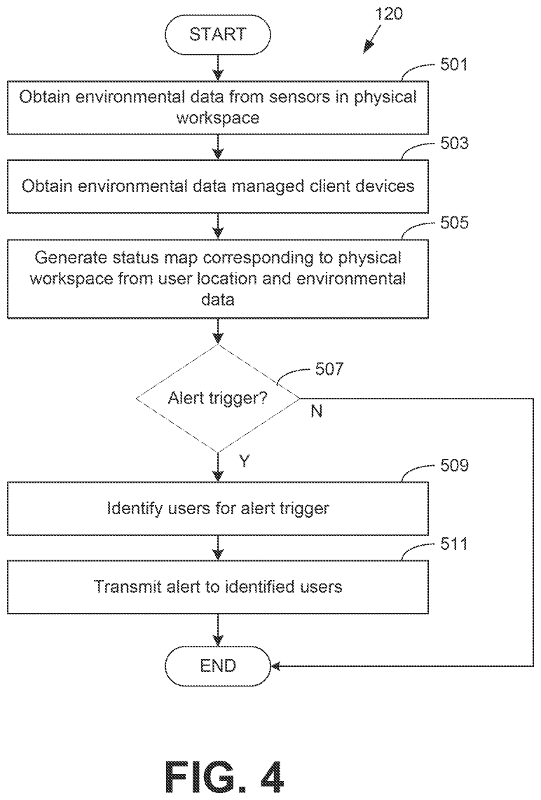

Referring next to FIG. 4, shown is a flowchart illustrating how the space utilization application 120 can generate alerts to enforce low noise or quiet areas. At step 501, the space utilization application 120 can obtain environmental data from the sensors 153 in the physical workspace 107. A sensor 153 can comprise a microphone, camera, network access point, such as a Wi-Fi access point, a beacon device, such as a Bluetooth beacon, motion sensors, occupancy sensors, or other types of sensors that can obtain information about the utilization of areas within a physical workspace 107.

At step 503, the space utilization application 120 can obtain environmental data from client devices 106 that are detected within the physical workspace 107. The client devices 106 can be detected within the physical workspace 107 based upon detection by beacon devices or Wi-Fi access points in the physical workspace 107. Additionally, a client device 106 can be detected as in the physical workspace 107 if the user utilizes a personal access credential on the device to access the physical workspace 107, such as via an access control device.

At step 505, the space utilization application 120 can generate a status map 128 corresponding to the physical workspace 107 based upon the environmental data. The status map 128 can represent a state of the physical workspace 107 based upon the environmental data obtained by the space utilization application 120. As noted above, the space utilization plan 129 generated by the space utilization application 120 can designate certain areas of a physical workspace 107 as quiet areas, congregation areas, social areas, high-traffic areas, low-traffic areas, or other area designations.

At step 507, the space utilization application 120 can determine whether sound levels from sensors 153 are exceeding a sound threshold specified for a low-noise or quiet area such that users should be notified to leave the area or lower noise levels. If the space utilization application 120 determines that sound levels are acceptable, the process can proceed to completion. If the space utilization application 120 determines that sound levels exceed a noise level threshold, the process can proceed to step 509.

At step 509, the space utilization application 120 can identify users in the area who should be alerted. Areas in the physical workspace 107 can be designated as silent or low noise by an administrator. These can be areas around meeting rooms or board rooms when important meetings are scheduled. Silent or low noise areas can also be areas around certain individual work spaces or offices. To enforce these restrictions, the space utilization application 120 can utilize an alerting mechanism when detected sound levels exceed a decibel level threshold or when an area becomes more crowded than a designated threshold. For example, if there are important meetings scheduled in a meeting room, an area in proximity to the meeting room could be designated as a silent area. Any users loitering within that space are alerted on their client device 106 and requested to move. Users can be detected within that space based upon their respective client device 106 being connected to a network access point in the area or if their respective devices are detected by a beacon.

At step 511, the space utilization application 120 can transmit the alert to the client device 106 of the users who are detected within the area. Thereafter, the process can proceed to completion.

The flowcharts of FIGS. 2-4 show examples of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIGS. 2-4 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The client device 106, computing environment 103, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 121, reservation application 149, and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All of these modifications and variations are intended to be included herein within the scope of this disclosure.

1. A system comprising:
at least one computing device;
a management service executable by the at least one computing device, the management service causing the at least one computing device to:
enroll each of a plurality of client devices for management by the management service, wherein enrolling comprises installing a management component on a client device, wherein the management component transmits state information including a location of the client device to the management service; and
a space utilization application executable by the at least one computing device, the space utilization application causing the at least one computing device to at least:
obtain the state information about the plurality of client devices enrolled with the management service;
obtain sensor data from a plurality of sensors associated with a physical workspace, wherein the sensor data makes up part of environmental data about the physical workspace;
generate a status map associated with the physical workspace based upon the state information about the plurality of plurality of client devices, wherein the status map includes locations of physical resources within the physical workspace and a location of each of the plurality of client devices in the physical workspace, wherein the status map is periodically updated;
determine a space utilization plan of the physical workspace based upon the status map and the environmental data; and
assign a user to the physical workspace based upon the space utilization plan.

2. The system of claim 1, wherein the space utilization application assigns the user to the physical workspace based upon a historical usage pattern of the physical workspace by the user, wherein the historical usage pattern is based upon data obtained from at least one of the plurality of client devices associated with the user.

3. The system of claim 2, wherein the historical usage pattern is based upon a previous booking of a previous physical resource within the physical workspace and the space utilization application assigns the user to a physical resource that is within a proximity threshold of the previous physical resource.

4. The system of claim 2, wherein the historical usage pattern is based upon a group membership of the user within a user directory and the space utilization application assigns the user to a physical resource that is within a proximity threshold of another member of the group within the physical resource.

5. The system of claim 1, wherein the sensor data comprises sound levels obtained from the plurality of sensors in the physical workspace and determining the space utilization plan comprises designating at least one area of the physical workspace as a quiet area based upon the obtained sound levels.

6. The system of claim 5, wherein the space utilization application transmits at least one notification to at least one of the plurality of client devices detected in the quiet area based upon the environmental data.

7. The system of claim 1, wherein determining the space utilization plan includes assigning a meeting to a physical resource within the physical workspace based upon at least one of a privacy level specified by an electronic meeting invitation or an analysis of at least one document attached to the electronic meeting invitation.

8. A method comprising:
enrolling a plurality of client devices for management by a management service, wherein enrolling comprises installing a management component on a client device, wherein the management component transmits state information including a location of the client device to the management service;
obtaining the state information about the plurality of client devices enrolled with the management service;
obtaining sensor data from a plurality of sensors associated with a physical workspace, wherein the sensor data makes up part of environmental data about the physical workspace;
generating a status map associated with the physical workspace based upon the state information about the plurality of plurality of client devices, wherein the status map includes locations of physical resources within the physical workspace and a location of each of the plurality of client devices in the physical workspace, wherein the status map is periodically updated;
determining a space utilization plan of the physical workspace based upon the status map and the environmental data; and
assigning a user to the physical workspace based upon the space utilization plan.

9. The method of claim 8, wherein assigning the user to the physical workspace is based upon a historical usage pattern of the physical workspace by the user, wherein the historical usage pattern is based upon data obtained from at least one of the plurality of client devices associated with the user.

10. The method of claim 9, wherein the historical usage pattern is based upon a previous booking of a previous physical resource within the physical workspace and the method further comprises assigning the user to a physical resource that is within a proximity threshold of the previous physical resource.

11. The method of claim 9, wherein the historical usage pattern is based upon a group membership of the user within a user directory and the method further comprises assigning the user to a physical resource that is within a proximity threshold of another member of the group within the physical resource.

12. The method of claim 8, wherein the sensor data comprises sound levels obtained from the plurality of sensors in the physical workspace and determining the space utilization plan comprises designating at least one area of the physical workspace as a quiet area based upon the obtained sound levels.

13. The method of claim 12, further comprising transmitting at least one notification to at least one of the plurality of client devices detected in the quiet area based upon the environmental data.

14. The method of claim 8, wherein determining the space utilization plan includes assigning a meeting to a physical resource within the physical workspace based upon at least one of a privacy level specified by an electronic meeting invitation or an analysis of at least one document attached to the electronic meeting invitation.

15. A non-transitory computer-readable medium comprising machine-readable instructions, wherein when executed by a processor of at least one computing device, the machine-readable instructions cause the at least one computing device to at least:
enroll a plurality of client devices for management by a management service, wherein enrolling comprises installing a management agent on a client device, wherein the management component transmits state information including a location of the client device to the management service;
obtain the state information about the plurality of client devices enrolled with the management service;
obtain sensor data from a plurality of sensors associated with a physical workspace, wherein the sensor data makes up part of environmental data about the physical workspace;
generate a status map associated with the physical workspace based upon the state information about the plurality of plurality of client devices, wherein the status map includes locations of physical resources within the physical workspace and a location of each of the plurality of client devices in the physical workspace, wherein the status map is periodically updated;
determine a space utilization plan of the physical workspace based upon the status map and the environmental data; and
assign a user to the physical workspace based upon the space utilization plan.

16. The non-transitory computer-readable medium of claim 15, wherein the instructions assign the user to the physical workspace based upon a historical usage pattern of the physical workspace by the user, wherein the historical usage pattern is based upon data obtained from at least one of the plurality of client devices associated with the user.

17. The non-transitory computer-readable medium of claim 16, wherein the historical usage pattern is based upon a previous booking of a previous physical resource within the physical workspace and the instructions assign the user to a physical resource that is within a proximity threshold of the previous physical resource.

18. The non-transitory computer-readable medium of claim 16, wherein the historical usage pattern is based upon a group membership of the user within a user directory and the instructions assign the user to a physical resource that is within a proximity threshold of another member of the group within the physical resource.

19. The non-transitory computer-readable medium of claim 15, wherein the sensor data comprises sound levels obtained from the plurality of sensors in the physical workspace and determining the space utilization plan comprises designating at least one area of the physical workspace as a quiet area based upon the obtained sound levels.

20. The non-transitory computer-readable medium of claim 19, wherein the instructions transmit at least one notification to at least one of the plurality of client devices detected in the quiet area based upon the environmental data.
